(19) United States
(12) Patent Application Publication
(10) Pub. No.: US 2006/0264521 A1
(43) Pub. Date: Nov. 23, 2006

(54) Process for the preparation of iron-oxide-and/or iron-oxyhydroxide-containing ion exchangers

(76) Inventors: Wolfgang Podszun, Koln (DE); Andreas Schlegel, Krefeld (DE); Reinhold Klipper, Koln (DE); Rudiger Seidel, Sandersdorf (DE); Udo Herrmann, Dormagen (DE)

Correspondence Address: LANXESS CORPORATION, 111 RIDC PARK WEST DRIVE, PITTSBURGH, PA, 15275-1112, US

(21) Appl. No.: 11/492,395

(22) Filed: Jul. 25, 2006

Related U.S. Application Data
(62) Division of application No. 10/865,419, filed on Jun. 10, 2004.

(30) Foreign Application Priority Data
Jun. 13, 2003 (DE) 10327112.0

(51) Int. Cl. C08J 5/20

(52) U.S. Cl. 521/25; 204/524

(57) ABSTRACT

The present invention relates to a process for the preparation of iron-oxide- and/or iron-oxyhydroxide-containing ion exchangers by polymerizing iron-oxide- and/or iron-oxyhydroxide-containing mixtures and functionalizing the resultant polymers.

This application is a divisional of U.S. patent application Ser. No. 10/865,419, filed Jun. 10, 2004, entitled “Process for the Preparation of Iron-Oxide and/or Iron-Oxyhydroxide-Containing Ion Exchangers”, the contents of which are hereby incorporated by reference in their entirety.

### BACKGROUND OF THE INVENTION

1. Field of the Invention

The present invention relates to a process for the preparation of iron-oxide- and/or iron-oxyhydroxide-containing ion exchangers by polymerizing iron-oxide- and/or iron-oxyhydroxide-containing mixtures, and functionalizing the resultant polymers.

2. Brief Description of the Prior Art

Ion exchangers are used in diverse ways for cleaning up untreated waters, wastewaters and aqueous process streams. They are particularly effective in softening and demineralizing. However, ion exchangers do not always have the desired selectivity. For example, it is not possible, using ion exchangers, to remove arsenate ions in the presence of elevated amounts of other anions, for example chloride or sulphate.

Iron oxide and/or iron oxyhydroxide are highly suitable for removing arsenate ions. For instance, DE-A 4 320 003 describes a process for removing dissolved arsenic from ground water by means of colloidal or granulated iron hydroxide. DE-A 10129306 describes an iron oxide and/or iron oxyhydroxide fly embedded in Fe(OH)₃ polymer and suitable for removing pollutants from wastewaters or off-gases. However, the use of colloidal or granulated iron oxide as adsorber for pollutants, is disadvantaged by the relatively high pressure drop in use and the low mechanical strength of the granules.

Superparamagnetic iron oxide enclosed in bead polymers e is disclosed in WO 02/04555 A1 for applications in diagnostics. These bead polymers have only a low tendency to adsorb pollutants, for example arsenic.

Sengupta et al., Ion Exchange at the Millennium, 142-149, 2000, discloses spherical macroporous cation exchangers, for example Purolite C-145, having submicron hydrated iron oxide (HFO) particles for adsorbing arsenicIII and arsenicV oxyanions.

The object of the present invention is to provide a process for the preparation of novel iron-oxide- and/or iron-oxyhydroxide-containing ion exchangers for removing pollutants, including arsenic, from liquids or gases.

### SUMMARY OF THE INVENTION

A process has now been found for the preparation of an iron-oxide- and/or iron-oxyhydroxide-containing ion exchanger which is characterized in that
I) a mixture of
   a) vinyl monomer
   b) crosslinker
   c) finely divided iron oxide and/or iron oxyhydroxide
   d) dispersion aid and
   e) free-radical initiator and, if appropriate,
   f) inert medium is produced,
II) the resultant mixture is cured in aqueous phase at elevated temperature to give a bead polymer and
III) the resultant bead polymer is converted into an ion exchanger by functionalization.

### DETAILED DESCRIPTION OF THE INVENTION

Vinyl monomers (a) within the meaning of the invention are compounds having, per molecule, one C═C double bond which can be polymerized by free-radical means. Preferred compounds of this type comprise aromatic monomers, for example vinyl derivatives and vinylidene derivatives of benzene and of naphthalene, for example vinylnaphthalene, vinyltoluene, ethylstyrene, α-methylstyrene, chlorostyrenes, styrene, and non-aromatic vinyl and vinylidene compounds, for example acrylic acid, methacrylic acid, acrylic acid C₁-C₈-alkyl esters, methacrylic acid C₁-C₈-alkylesters, acrylonitrile, methacrylonitrile, acrylamide, methacrylamide, vinyl chloride, vinylidene chloride and vinyl acetate. Preference is given to styrene, acrylic acid C₁-C₂-alkyl esters, methacrylic acid C₁-C₂-alkyl esters and acrylonitrile. Of course, mixtures of different monomers can be used. The vinyl monomer is employed in an amount sufficient to provide an effective polymerization. The content of vinyl monomer is generally 50 to 99% by weight, preferably 84 to 98% by weight, based on the sum of a) and b).

Crosslinkers (b) to be used according to the invention are compounds which contain, per molecule, two or more, preferably two to four, double bonds which can be polymerized by free-radical means. Those which may be mentioned by way of example are: divinylbenzene, divinyltoluene, trivinylbenzene, divinylnaphthalene, trivinylnaphthalene, diethylene glycol divinyl ether, octadi-1,7-ene, hexadi-1,5-ene, diethylene glycol divinyl ether and butanediol divinyl ether. The content of crosslinker is generally 1 to 50% by weight, preferably 2 to 16% by weight, based on the sum of components (a) and (b).

Finely divided iron oxide and/or iron oxyhydroxide (c) are taken to mean solid particulate oxides and/or oxyhydroxides of iron. Preference is given to oxides and oxyhydroxides of trivalent iron, in which case a certain proportion of divalent iron does not interfere. Non-magnetic oxides and oxyhydroxides of iron are preferred. α-FeOOH is particularly highly suitable. The primary particle size of the iron oxide and/or iron oxyhydroxide is 0.01 to 1.0 μm and preferably 0.02 to 0.3 μm. In the case of needle-shaped particles, primary particle size means the length. It is possible, and because of the greater ease of handling, it is generally advantageous, to use iron oxide and/or iron oxyhydroxide which is not in the form of the isolated primary particles but in the form of agglomerates or granules. The agglomerates or granules can have particle sizes of 0.2 to 50 μm, preferably 0.3 to 10 μm, particularly preferably 0.4 to 5 μm. If the starting material is present in coarser form, it can be comminuted to the desired size using mills, for example ball mills. The iron oxide and/or iron oxyhydroxide is used in an amount of 1 to 60% by weight, preferably 2.5 to 40% by weight, based on the sum of the components (a), (b) and (c).

Dispersion aids (d) which can be used according to the invention are low-molecular-weight and high-molecular-weight compounds which are soluble in the components (a) and (b). High-molecular-weight compounds which may be mentioned are: poly(methylmethacrylate), copolymers of (meth)acrylic acid esters and (meth)acrylic acid, styrene-maleic anhydride copolymers, poly(vinyl acetate), acetalized poly(vinyl alcohol)s, copolymers of vinyl acetate and N-vinylpyrrolidone, and also block copolymers of, for example, acrylonitrile and butadiene.

Low-molecular-weight dispersion aids (d) are, for example, C₈-C₂₄ carboxylic acids and amides thereof. Examples which may be mentioned are undecanoic acid, stearic acid, oleic acid, cetylamide. Other suitable compounds are sulphonic acid and phosphonic acids having 6 to 18 carbon atoms, and alkali metal salts thereof. The dispersion aid is used in an amount of 0.05 to 25% by weight, preferably 0.1 to 2.5% by weight, based on the sum of the components (a) and (b).

Free-radical initiators e) which are suitable for the inventive process are azo compounds, for example 2,2′-azobis(isobutyronitrile) and 2,2′-azobis(2-methylisobutyronitrile) and peroxy compounds, such as dibenzoyl peroxide, dilauryl peroxide, bis(p-chlorobenzoyl peroxide), dicyclohexyl peroxydicarbonate, tert-butyl peroxy-2-ethylhexanoate, 2,5-bis(2-ethylhexanoylperoxy)-2,5-dimethylhexane, tert-butyl peroxybenzoate and tert-amyl peroxy-2-ethylhexane. It is of course possible, and in many cases advantageous, to use mixtures of different free-radical initiators, for example free-radical initiators having different decomposition temperatures. The free-radical initiators are generally used in amounts of 0.05 to 1%, preferably 0.1 to 0.8%, based on the sum of the components (a) and (b).

An inert medium to be used, if appropriate, can be non-reactive liquids which mix with the components (a) and (b). Examples which may be mentioned are toluene, xylene, isoamyl acetate. If it is desired to produce a macroporous iron-oxide- and/or iron-oxyhydroxide-containing ion exchanger, inert media having a porogenic action can be used. Those which may be mentioned by way of example are isooctane, isododecane, octanol, butyldiglycol and butanediol. The inert medium is used in an amount of 0 to 150% by weight, preferably 0 to 80% by weight, based on the sum of the components (a) and (b).

The mixture of the components (a) to (f) can be produced by conventional methods in customary mixers or agitators.

In a particular embodiment of the present invention, first, using a mill, preferably a ball mill, a suspension of the finely divided iron oxide and/or iron oxyhydroxide (c) is produced in a liquid selected from the components (a), (b) and/or (f), using the dispersion aid (d), and thereafter the remaining components are added. To prevent premature polymerization, the free-radical initiator (e) is, expediently, not added until immediately before process step (II) is carried out.

The mixture is cured in aqueous phase in the presence of one or more protective colloids and, if appropriate, a buffer system. Protective colloids which are suitable are natural and synthetic water-soluble polymers, for example gelatin, starch, poly(vinyl) alcohol, polyvinylpyrrolidone, poly(acrylic acid), poly(methacrylic acid) and copolymers of (meth)acrylic acid and (meth)acrylic acid esters. Cellulose derivatives are also very highly suitable, in particular cellulose esters and cellulose ethers, such as carboxymethylcellulose, hydroxyethylcellulose and hydroxyethylmethylcellulose. Cellulose derivatives are preferred as protective colloid. The amount of the protective colloids used is generally 0.05 to 1% by weight, based on the water phase, preferably 0.1 to 0.5% by weight.

The curing can be carried out in the presence of a buffer system. Preference is given to buffer systems which set the pH of the water phase at the start of polymerization to between 14 and 6, preferably between 13 and 9. Under these conditions, protective colloids containing carboxylic acid groups are present wholly or partly as salts. In this manner the action of the protective colloids is favourably affected. Particularly highly suitable buffer systems comprise phosphate salts or borate salts.

Salt, for example sodium chloride or calcium chloride, can be added to the aqueous phase to decrease the solubility of component (a) in water. This measure is particularly advisable if the component (a) comprises acrylonitrile as vinyl monomer. The amount of the water phase during curing is 60 to 1000%, preferably 100 to 200%, based on the mixture of the components (a) to (e).

The temperature during curing depends on the decomposition temperature of the free-radical initiator used. It is generally between 50 and 150° C., preferably between 60 and 130° C. The polymerization lasts 1 to some hours, for example 10 h. It has proven useful to employ a temperature programme in which the polymerization is started at low temperature, for example 60° C., and the reaction temperature is increased with advancing polymerization conversion rate. In this manner the requirement, for example, for a reliable reaction course and high polymerization conversion rate may very readily be complied with.

After curing the bead polymer formed can be isolated by conventional methods, for example by filtering or decanting, and if appropriate after one or more washes, can be dried and, if desired, screened.

The bead polymer formed can be functionalized to form the ion exchanger by methods which are known per se.

To produce a weakly acidic iron-oxide- and/or iron-oxyhydroxide-containing ion exchanger, as vinyl monomer (a), acrylic acid methyl ester and/or acrylonitrile is used and the resultant bead polymer is functionalized by alkaline saponification of the ester or nitrile groups to form weakly acidic groups. As alkaline saponification agent, use is made of aqueous, alcoholic or aqueous-alcoholic solutions of alkali metal hydroxides and alkaline earth metal hydroxides. Preference is given to aqueous alkali solutions such as potassium hydroxide solution, and in particular sodium hydroxide solution. The concentration of the alkali solution used is 5 to 60% by weight, preferably 10 to 50% by weight.

The amount of alkali solution is chosen so as to set an alkali excess of 10 to 300 mol %, preferably 50 to 200 mol %, based on the amount of the nitrile groups or ester groups to be saponified.

Preferably, the alkaline saponification is carried out at temperatures of 110 to 150° C. under pressure. Alternatively, atmospheric-pressure saponification using aqueous sodium hydroxide solution is also possible. To carry out the pressurized saponification, reference is made to EP-A-0 406 648. Preferably, the bead polymer is charged first and the aqueous sodium hydroxide solution is added. After saponification is terminated, the resultant ion exchanger is washed to neutrality at, for example, 90° C. For further purification, the ion exchanger can be treated with water or steam at elevated temperature. Finely divided constituents can then be removed in a classification column.

The bead polymer can be functionalized to form an iron-oxide- and/or iron-oxyhydroxide-containing anion exchanger by chloromethylation and subsequent amination.

For the chloromethylation, preferably chloromethyl methyl ether is used. The chloromethyl methyl ether can be used in non-purified form, in which case it can comprise, as minor components, for example methylal and methanol. The chloromethyl methyl ether is preferably used in excess and acts not only as reactant, but also as solvent and swelling medium. The use of an additional solvent is therefore not generally necessary. The chloromethylation reaction is catalysed by addition of a Lewis acid. Suitable catalysts are, for example, iron(III) chloride, zinc chloride, tin(IV) chloride and aluminium chloride. The reaction temperature can be in the range from 40 to 80° C. In the case of the atmospheric-pressure procedure, a temperature range of 50 to 60° C. is particularly favourable. During the reaction the volatile constituents, such as hydrochloric acid, methanol, methylal can be removed by evaporation. To remove the residual chloromethyl methyl ether and to purify the chloromethylate, the product can be washed with methylal, methanol and finally with water.

To produce weakly basic anion exchangers, the chloromethylated copolymer is reacted with ammonia, a primary amine such as methylamine or ethylamine, or preferably with a secondary amine such as dimethylamine.

The reaction with tertiary amines leads to strongly basic anion exchangers. Suitable tertiary amines are trimethylamine, dimethylaminoethanol, triethylamine, tripropylamine and tributylamine.

Complete reaction of the chloromethylated copolymer requires at least 1 mol of amine, based on 1 mol of chlorine in the chloromethylate. Preference is given to a slight amine excess. Particular preference is given to 1.1 to 1.3 mol of amine per mole of chlorine.

The amination reaction is performed in the presence of water or water-methanol mixtures. During the amination, the resin continuously absorbs water and thus swells. Therefore a minimum amount of water is necessary to keep the batch stirrable. Per gram of chloromethylated bead polymer, at least 1.5 grams, preferably 2 to 4 grams, of water are to be used.

The temperature at which the amination is carried out can be in the range between room temperature and 160° C. Preferably, temperatures between 70 and 120° C., particularly preferably in the range between 70 and 110° C., are employed.

After the amination, the resultant anion exchanger is washed with water and then treated in deionized water at temperatures of 20 to 120° C., preferably 50 to 90° C. The product is isolated, for example, by allowing it to settle, or by filtration.

The inventive anion exchangers can be converted into other forms, for example into the OH form, in known ways by exchange of the chloride ion for a different counterion.

The iron-oxide- and/or iron-oxyhydroxide-containing ion exchangers obtained by the inventive process are distinguished by a particularly high adsorption of arsenic.

The inventive iron-oxide- and/or iron-oxyhydroxide-containing ion exchangers and bead polymers according to stage II can be used for purifying drinking water, cleaning of wastewater streams of the chemical industry and of refuse incineration plants. A further use of the inventive ion exchanger is the clean up of leachate waters from landfills.

The inventive iron-oxide- and/or iron-oxyhydroxide-containing iron exchangers and bead polymers according to stage II are preferably used in apparatuses.

The invention therefore also relates to apparatuses through which liquid to be treated can flow, preferably filtration units, particularly preferably adsorption vessels, in particular filter adsorption vessels, which, charged with the iron-oxide- and/or iron-oxyhydroxide-containing ion exchangers or bead polymers according to stage II are obtainable by the processes described in this application, are used for removing heavy metals, in particular arsenic, from aqueous media, preferably drinking water. The apparatuses can be connected, for example, in the home, to the sanitary and drinking water supplies.

### EXAMPLES

### Example 1

Production of a Weakly Acidic Iron-Oxyhydroxide-Containing Ion Exchanger

a) Production of an Iron Oxyhydroxide-Containing Bead Polymer

An aqueous solution of 2.621 g of methylhydroxyethylcellulose, 87.4 g of sodium chloride, 0.920 g of a methylene-linked condensation product of arylsulphonic acids (Retingan® ZN) and 636.8 g of deionized water is charged into a 4 litre flat-flange reactor equipped with gate agitator, condenser, temperature sensor and thermostat and chart recorder.

In a separate stirred vessel, 39.2 g of poly(methyl acrylate) are dissolved in 290.1 g of acrylonitrile and 23.52 g of diethylene glycol divinyl ether. To this solution are added 39.2 g of iron oxyhydroxide (α-FeOOH) in the form of agglomerated particles having a particle size of 5 μm and the mixture is dispersed for 4 min at 24 000 rpm using a rotor-stator mixer. 1.05 g of dibenzoyl peroxide 75 W are then added and are dissolved within 15 min in the resultant dispersion.

The activated iron-oxyhydroxide-containing dispersion is introduced, through an elongated funnel, with stirring at 200 rpm, into the prepared 4 litre flat-flange reactor, below the surface of the aqueous phase. The mixture is then heated to 70° C., a nitrogen stream of 20 l/min being passed over in the first 15 min. The mixture is heated for 7 h at 70° C., then heated to 90° C. and held at 90° C. for a further 5 h. After cooling, the polymer is washed over a 100 μm screen with copious water, then dried at 80° C. This produces 337.9 g of brown beads having a mean particle size of 480 μm.

b) Production of an Iron-Oxide- and/or Iron-Oxyhydroxide-Containing Weakly Acidic Ion Exchanger

1240 g of deionized water are charged into a 4 litre flat-flange reactor equipped with gate agitator, distillation bridge, temperature sensor and also thermostat and chart recorder, and are suspended with 200 g of the bead polymer from (a) with stirring at 200 rpm. At a temperature of 100° C., 274.4 g of 50% strength by weight sodium hydroxide solution are added in the course of 2 hours. Then a further 1371.9 g of 50% strength by weight sodium hydroxide solution are added in the course of 75 min. Thereafter, at a mantle temperature of 125° C., 1 litre of water is distilled off and the batch is cooled. The product is then transferred to a column and washed to neutrality with deionized water. This produces 780 ml of brown weakly acidic ion exchanger having a mean particle size of 740 μm.

### Example 2

a) Production of an Iron-Oxide- and/or Iron-Oxyhydroxide-Containing Bead Polymer

In a ball mill equipped with ceramic balls, 40 g of iron oxyhydroxide (α-FeOOH) are dispersed in a mixture of 40 g of oleic acid and 100 g of xylene. 85.98 g of this dispersion are stirred with 260.8 g of acrylonitrile and 17.20 g of diethylene glycol divinyl ether. After homogeneous mixing, 0.97 g of dibenzoyl peroxide 75 W are dissolved therein in the course of 15 min.

This mixture is introduced into a 4 litre flat-flange reactor which was equipped with gate agitator, condenser, temperature sensor and cooling/heating mantle, and a solution of 2.621 g of methylhydroxyethylcellulose, 87.4 g of sodium chloride, 0.920 g of a methylene-linked condensation product of arylsulphonic acid (Retingan® ZN) and 636.8 g of deionized water is introduced at an agitator speed of 200 rpm. Thereafter the mixture is heated to 70° C., a nitrogen stream of 20 l/min being passed over in the first 15 min. The mixture is heated for 7 h at 70° C., then heated to 90° C. and held at 90° C. for a further 5 h. After it is cooled, the polymer is washed with copious water over a 100 μm screen, then dried at 80° C. This produces 265.3 g of brown beads having a mean particle size of 390 μm.

b) Production of an Iron-Oxide- and/or Iron-Oxyhydroxide-Containing Weakly Acidic Ion Exchanger

200 g of bead polymer from 2a) are saponified in accordance with the procedure described in Example 1b). This produces 810 ml of brown weakly acidic ion exchanger having a mean particle size of 600 μm.

It will be understood that the specification and examples are illustrative but not limitative of the present invention and that other embodiments within the spirit and scope of the invention will suggest themselves to those skilled in the art.

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. An iron-oxide- and/or iron-oxyhydroxide-containing ion exchangers obtained by
I) producing a mixture of vinyl monomer, crosslinker, finely divided iron oxide and/or iron oxyhydroxide, dispersion medium and free radical initiator,
II) curing the resultant mixture in aqueous phase at elevated temperature to give a bead polymer and
III) converting the resultant bead polymer into an ion exchanger by functionalization.

2. A process for adsorbing arsenic and for purifying drinking water, cleaning up wastewater streams of the chemical industry and of refuse incineration plants, for cleaning up leachate waters from landfills or for removing pollutants from liquids or gases comprising contacting the same with the iron-oxide- and/or iron-oxyhydroxide-containing ion exchangers according to claim 1.

3. A process for adsorbing arsenic and for purifying drinking water, cleaning up wastewater streams of the chemical industry and of refuse incineration plants, for cleaning up leachate waters from landfills or for removing pollutants from liquids or gases comprising contacting the same with the iron-oxide- and/or iron-oxyhydroxide-containing ion exchangers according to claim 1.

4. An apparatus for removing heavy metal from fluid, comprising the iron-oxide- and/or iron-oxyhydroxide-containing ion exchangers according to stage II of claim 1, disposed therein to contact the fluid flowing the apparatus.

5. The apparatus of claim 4 wherein the iron-oxide- and/or iron-oxyhydroxide containing ion exchangers are contained in a filtration unit.

6. The apparatus of claim 4 wherein the iron-oxide- and/or iron-oxyhydroxide containing ion exchangers are contained in an absorption vessel.
